(19) United States
(12) Patent Application Publication
(10) Pub. No.: US 2026/0225255 A1
(43) Pub. Date: Aug. 6, 2026

(54) DYNAMIC MECHANICAL SKIN STRUCTURES FOR ANIMATRONIC FIGURES

(71) Applicant: DISNEY ENTERPRISES, INC., Burbank, CA (US)

(72) Inventors: Alfredo Medina Ayala, West Covina, CA (US); Joel Jason Peavy, Poway, CA (US); Bryan S. Tye, Canyon County, CA (US); David Powell Goldberg, Altadena, CA (US)

(21) Appl. No.: 19/407,596

(22) Filed: Dec. 3, 2025

Related U.S. Application Data
(60) Provisional application No. 63/755,000, filed on Feb. 6, 2025.

(51) Int. Cl. B25J 11/00; B25J 9/10; B25J 9/14; H04N 9/31

(52) U.S. Cl. CPC B25J 11/0015; B25J 9/1085; B25J 9/142; H04N 9/3182

(57) ABSTRACT

An animatronic may include a shell, a skin coupled to the shell, and an actuator configured to selectively create a deformation of the skin, wherein the deformation is configured to complement content projected onto the skin. The skin may cover the shell. The actuator may be mechanically coupled to the skin. The actuator may move the skin to change a topography of the skin to mimic a facial expression. The skin may define a continuous projection surface. A projector may project content onto the projection surface.

### CROSS REFERENCE TO RELATED APPLICATIONS

The present application claims the benefit of and priority to U.S. Provisional Patent Application No. 63/755,000 filed on Feb. 6, 2025, which is incorporated by reference herein in its entirety.

### FIELD

The present disclosure relates generally to systems and methods for controlling and implementing robotic devices, such as animatronic figures, and more specifically to dynamic mechanical skin structures for animatronic figures.

### BACKGROUND

Amusement parks, theme parks, carnivals, arcades, and various attractions use robotic devices, such as animatronic figures, to produce an interactive effect for guests. For example, animatronic figures mimic the movement, look, and emotion of characters sharing the theme of the rides, shows, and games, and can interact with guests to provide a truly immersive experience. Additionally, other types of robotic devices appear in everyday life such as in food service environments, manufacturing environments, and social interaction environments, interacting with users and the environment.

### SUMMARY

In one example, an animatronic includes a shell, a skin coupled to the shell, and an actuator configured to selectively create a deformation of the skin, wherein the deformation is configured to complement content projected onto the skin.

Optionally, the actuator includes a mechanical transmission configured to provide a positive or negative displacement of the skin at a location.

Optionally, the shell includes a fixed portion and a movable portion, wherein the actuator is configured to move the movable portion relative to the fixed portion to create the deformation. The skin may span over the fixed portion and the movable portion, wherein the skin is configured to move with the movable portion relative to the fixed portion.

Optionally, the skin includes an inner substrate coupled to the actuator. The animatronic may include a mechanical attachment coupling the skin to the shell.

Optionally, the actuator abuts an inner surface of the skin, such that the deformation is only caused by a positive displacement of the actuator.

Optionally, the skin includes an inner substrate, a relief, or a void to define a localized deformation of the skin. The substrate, the relief, or the void may define a directional stiffness of the skin to define the shape.

Optionally, the skin includes multiple substrates, multiple reliefs, or multiple voids to define the localized deformation of the skin.

Optionally, a system may include the animatronic and a projector configured to project the content onto the skin.

In another example, an animatronic includes a shell, a skin covering the shell, and an actuator system configured to move the skin to change a topography of the skin to mimic a facial expression.

Optionally, the actuator system includes a movable portion of the shell and an actuator configured to move the movable portion.

Optionally, the actuator system includes a motor and a linkage, wherein the skin includes an attachment coupling the linkage to the skin. The skin may include an inner substrate defining the attachment.

Optionally, the actuator system includes a bladder associated with the skin, the bladder configured to change shape based on a fluid pressure within the bladder. The bladder may be attached to an inner surface of the skin.

In another example, a robotic system includes a shell, a skin coupled to the shell and defining a continuous projection surface, a projector configured to project content onto the continuous projection surface, and an actuator system mechanically coupled to the skin and configured to selectively create a deformation of the skin that complements the content projected onto the skin.

Optionally, the actuator system includes a motor and a linkage coupling the motor to the skin.

Optionally, the actuator system includes an actuator and a bladder, wherein the actuator includes a pneumatic or hydraulic actuator, and wherein the bladder is configured to change shape based on a fluid pressure within the bladder.

Optionally, the actuator system includes a shape memory alloy or a tensile element.

### BRIEF DESCRIPTION OF THE DRAWINGS

FIG. 1 illustrates a simplified schematic of a system for performing dynamic projection mapping onto animatronic figures in real-time.

FIG. 2A illustrates an example animatronic figure with a projection surface positioned over a robotic structure of the animatronic figure.

FIG. 2B illustrates an example of a projection surface of an animatronic figure modified to align with content projected onto it.

FIG. 2C illustrates an example of a projection surface of an animatronic figure and a projection surface of an animatronic figure modified to align with content projected onto it.

FIG. 3A illustrates a cross-section side view of a projection surface with an actuator that is at rest.

FIG. 3B illustrates a cross-section side view of a morphed projection surface with an activated actuator.

FIG. 3C illustrates a cross-section side view of a projection surface with mechanical means for modifying the topography of the projection surface.

FIG. 4A illustrates a simplified schematic of an actuator system for mechanically moving a projection surface of an animatronic figure, with the actuator system providing a positive displacement of the projection surface at a location.

FIG. 4B illustrates the actuator system of FIG. 4A, with the actuator system providing a negative displacement of the projection surface at the location.

FIG. 5 illustrates a first set of shaping features configured to define a shape of a projection surface of an animatronic figure.

FIG. 6 illustrates a second set of shaping features configured to define a shape of a projection surface of an animatronic figure.

FIG. 7A illustrates a first example of a third set of shaping features configured to define a shape of a projection surface of an animatronic figure.

FIG. 7B illustrates a second example of the third set of shaping features.

FIG. 7C illustrates a third example of the third set of shaping features.

FIG. 8A illustrates a first example of a fourth set of shaping features configured to define a shape of a projection surface of an animatronic figure.

FIG. 8B illustrates a second example of the fourth set of shaping features.

FIG. 9A illustrates a first example transmission for transferring a motive force to a shaping feature.

FIG. 9B illustrates a second example transmission for transferring a motive force to a shaping feature.

FIG. 9C illustrates a third example transmission for transferring a motive force to a shaping feature.

FIG. 10A illustrates a first example actuator for providing a motive force for an example actuator system.

FIG. 10B illustrates a second example actuator for providing a motive force for an example actuator system.

FIG. 10C illustrates a third example actuator for providing a motive force for an example actuator system

FIG. 11 illustrates a front view of an example implementation of a robotic system.

FIG. 12 illustrates a rear view of the robotic system of FIG. 11.

FIG. 13 illustrates a simplified block diagram of components of a computing system.

### DETAILED DESCRIPTION

Embodiments herein introduce a procedure for animating a robotic device (e.g., an animatronic figure), such as animation of a portion of a face, limb, or other element of the animatronic figure. It should be noted that while many embodiments described herein are with reference to an animatronic figure, the embodiments are equally applicable to other types of movable systems, such as other robotic devices (hereinafter “animatronic” or “animatronic figure” without intent to limit). The animation includes a hybrid approach using mechanical actuators combined with content projection, where the content is projected onto a projection surface of the animatronic (e.g., an outer covering or skin of the animatronic). The projection surface or skin may be continuous (e.g., without apertures or other breaks in the skin) or noncontinuous.

A system provides mechanical motion to move or deform portions of the projection surface or skin of the animatronic figure. The content projection enhances and supplements the mechanical motion. For example, animation, detailed realism, special effects, and artistic elements of facial features, including, but not limited to, skin texture, color, macro and micro animations, wrinkles, cinematic effects, visual effects (VFXs), etc. are projected along with mechanical motion representative of the same animated effect. The overall effect of the mechanical and projected content creates a realistic and immersive experience not possible to generate solely with mechanical motion. The combination of topography changes (e.g., via mechanical motion) with the content projection over the same surface of the animatronic introduces realism and allows more complex and detailed animations for the animatronic, many of which would not be possible to create with just mechanical motion or with just content projection, such as finer or faster motions that cannot be done with mechanical actuators. The animation of the animatronic figure includes various human or non-human facial features, expressions, emotions, motions, and other animations of the sort that an animatronic figure is to perform or represent. In short, the content projection enhances bulkier movement of the mechanical portions of the projection surface of the animatronic to generate effects not possible with conventional techniques.

In some embodiments, a position, orientation, or pose of the animatronic figure is tracked or otherwise identified using a combination of one or multiple tracking or position identification methods. In many instances, the orientation may be tracked in real-time to ensure alignment and accurate projection between the projected content and the mechanical movement of the projection surface. For example, the tracked pose of the animatronic figure is used by a real-time rendering engine to render a desired image (e.g., desired artistic content) to be projected onto the animatronic figure by one or more projectors based on the position (e.g., topography, deformation, pose) of the features of the projection surface. By helping to avoid misalignment between the content and the motion, the realism is enhanced, whereas misalignment will detract from the realism.

As compared to conventional methods, the realistic appearance is enhanced by increased fidelity and detail of the animation. Further, the projected animation contains more degrees of freedom than possible in traditional animatronic figures. In some embodiments, the animatronic figure may be animated more consistently compared to traditional animatronic figures as a number of artistic elements within the projected content, e.g., color, motion, smoothness, etc., will be the same even if the mechanical components or skins are changed over time (e.g., actuators slow or skin colors change). In some examples, the skins or other coverings defining the projection surfaces for the animatronic figures do not need to deform as much (e.g., can have a shorter/smaller range of motion) as compared with traditional animatronic figures. As a result, the lifespan of such coverings may last much longer as compared to transitional animatronics. Additionally, in some cases, special effects may be employed for the animation of the animatronic figure that are not possible using traditional techniques, such as enabling animated figures to blush, cry, or be animated to perform any other effects that can be projected.

In some embodiments, multiple considerations on designing the topography of the face of the animatronic figure (or any other part of the animatronic figure) may be introduced. For example, instead of using a traditional animatronic face with functions that move skin, in some embodiments, facial functions may be designed that morph the skin topography to serve as a projection surface and ensure continuity of a projection surface. For example, the mouth of the animatronic figure may not be a physical mouth aperture, but rather the face skin can stretch over the mouth aperture or recess (e.g., as a mouth bag), and the projected content defines the image of the inside of the mouth with teeth and a tongue. The mouth bag may move (e.g., via an actuator) to deform the topography of the projection surface to showcase the mouth and any motion and movement that may be performed by the mouth. The projection surface helps to ensure that the content has a surface onto which it can be projected. As another example, eyebrow functions of the animatronic figure may morph the topography of the skin of and around the eyebrows (e.g., push out the skin, slide the skin up/down, tilt the skin) to create an embossment in the shape of the eyebrow in the desired position. In some examples, extra material may be included in the projection surface in areas where the projection surface may need to be extensively manipulated or deformed to match an intended character or emotion (e.g., a longer nose, horns, or a defined larger chin).

In various cases, the projection surface may be made of silicon as silicon may elastically deform via actuators or other mechanical means while being able to return to the original shape reducing the risk of tearing. Additionally, silicon may allow for the embedding of attachment points (e.g., attachment to actuators, or attachment to the animatronic figure), while still retaining the ability to elastically deform. In various other cases, the projection surface may be made up of different materials such as neoprene, latex, cloth, elastomers (e.g., self-healing or liquid crystal), etc. Said materials may be used in combination with the silicon or in combination with one another to make up the projection surface. In some examples, the projection surface may include different surface finishes depending on the intended implementation of the animatronic. For example, a matte finish may be used for dramatic emotional implementations, while a reflective finish may be used for cartoony implementations. In some examples, the projection surface may include different thickness across the projection surface to allow for more deformation or for less deformation to better match the intended character or emotion. Additionally, the difference in thicknesses across the projection surface may allow for different projections show up better on certain thicknesses of the projection surface.

In various embodiments, the projection surface may be tied or coupled to the animatronic figure (e.g., a shell portion of the animatronic figure) as to allow for the manipulation and deforming of the projection surface while not impacting the final topography of the manipulated/deformed projection surface. In some instances, anchors may be used to couple the projection surface to the animatronic figure, such as anchors that attach to the shell or anchors that snap onto the shell. In some instances, magnetic anchors may be used to tie the projection surface to the animatronic figure. In some instances, anchors may be manufactured into the projection surface (e.g., embedded) and not positioned/added to the projection surface after the manufacturing of the projection surface.

The hybrid procedure for morphing of the skin topography to serve as a projection surface discussed may be combined with traditional methods of moving an animatronic figure. For example, conventional actuators may be used to turn the head of the animatronic figure (e.g., left and right), while the skin of the head may be morphed according to embodiments herein to move features of the head (e.g., eyebrows, wrinkles, nose features, mouth features, etc.) in a certain way.

The hybrid design of the topography of the face of the animatronic figure can apply to any other function that may need to morph and deform the skin into a desired shape for the projection. Note that appropriate designs may vary depending on the character mimicked by the animatronic figure and the intended animations to be performed by the animatronic figure.

Portions of the face of the animatronic figure that do not move may be given additional consideration. For example, traditional animatronics use large amounts of surface detailing in the face, however embodiments herein use a hybrid projection face with limited surface detailing. Traditional animatronic figures include certain details (e.g., molded areas of the covering) that may create deep creases and crevices in the face skin topography that would occlude light, e.g., create shadows or prevent accurate projection onto the surface. Additionally, the more defined a facial detail is, as is done in traditional animatronic figures, the less flexible it is for a dynamic projection media that needs to animate and change over the top of it. Embodiments herein include smooth projection surfaces on specific parts of the projection surface of the animatronic figure that will be needed for dynamic projection animations and parts that are sensitive to light occlusion. As a result, the animatronic figure may be flexible for dynamic projection media.

In some embodiments, various procedures may be used to morph the topography of the face or projection surface of the animatronic figure. Morphing the topography of the face or projection surface of the animatronic figure may be understood as defining concave section(s) of the projection surface to emphasize features that will be projected on. In some cases, an electromechanical actuation, such as motors and other types of electric actuators, may be used to morph the topography of the face or projection surface of the animatronic figure. For example, actuators (or motors) may be linked to the topography of the face or projection surface of the animatronic figure using a rigid link, using pneumatic tubing, or using tensile element linkage.

In some other cases, different fluids or gasses may be used to move the skin adjusting the topography of the face or projection surface (e.g., in bags placed underneath the projection surface). In yet some other cases, combinations of chemical or electrochemical actuation may be used to adjust the topography of the face or projection surface of the animatronic figure. In yet some other cases, geometric lattice optimization and design may be used to form certain desired shapes when deformed, in some examples, with the other procedures for morphing the topography of the face or the projection surface of the animatronic figure. In yet some other cases, linear pneumatic actuators may be used to adjust the topography of the face or projection surface of the animatronic figure. In yet some other cases, a shape memory alloy may be used to adjust the topography of the face or projection surface of the animatronic figure. Additionally, gradient material properties design may be used to adjust the topography of the face of projection surface of the animatronic figure. A combination of the discussed procedures can be used together by mixing algorithmic and procedural methods for dynamic topography optimization for projection.

Embodiments herein may lower the design and fabrication costs of the mechanical face of the animatronic figure, as there are fewer mechanical functions (e.g., such as actuators) for the simplified face using the projection surface. Additionally, embodiments herein may lower the maintenance cost of the animatronic figure as there are fewer components that may break down. Moreover, in some embodiments, the design of the skin of the animatronic figure is a continuous projection surface in that the skin may not include apertures or other breaks in the skin, which traditionally define stress points that rip and tear over time, such as eye apertures or the corners of the mouth. Such a configuration helps to reduce wear and tear on the skin of the animatronic figure, increasing life span of the skin of the animatronic figure and the animatronic figure itself. Further, embodiments herein increase the viewing angle and realism of the animatronic figure as the continuous projection surface may wrap around the animatronic figure and the proportions of the animatronic figure with the continuous projection surface may remain the same. Accordingly, from the side or from the back, the animatronic figure may still look as the intended character/implementation, whereas traditional animatronic figures may look robotic and unnatural due to different surfaces, apertures, as one looks around a traditional animatronic figure (e.g., side and back views).

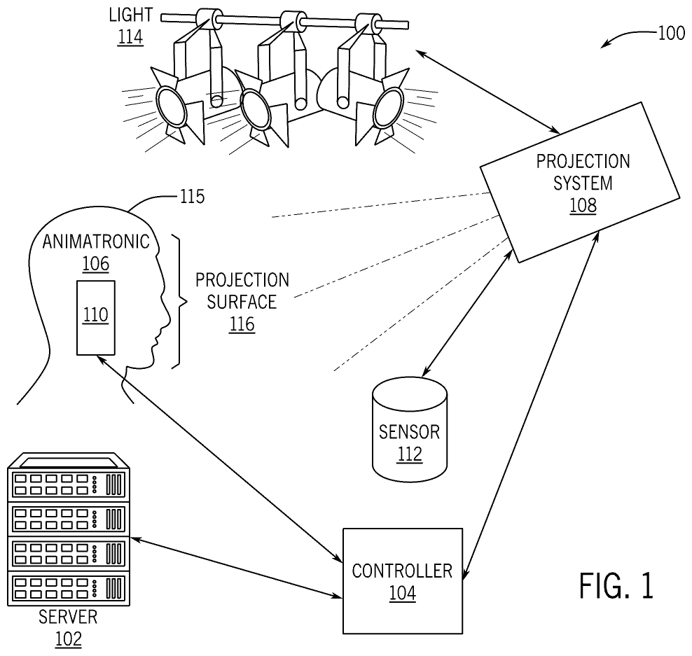

Turning to the figures, FIG. 1 illustrates a simplified schematic of a system 100 for performing dynamic projection mapping onto animatronic figures in real-time. The system 100 includes a server 102, a controller 104, an animatronic figure (hereinafter “animatronic”) 106 (including an actuator 110), a projection system 108, one or more sensors (hereinafter “sensors”) 112, and one or more lights (hereinafter “lights”) 114.

The animatronic 106 may include a skin 115. The skin 115 may define one or more projection surfaces 116 onto which content may be projected. In this manner, the projection surface 116 may be a surface covering at least a portion of the animatronic 106, e.g., a head of the animatronic 106 or any other part of the animatronic 106 desired to be animated. The projection surface 116 may cover a single moving surface or multiple moving surfaces of the animatronic 106. The animatronic 106 may receive mechanical inputs from the controller 104 and performed by one or more actuators (hereinafter “actuator”) 110 as to change the topography or otherwise deform the projection surface 116. This may be achieved using the actuator 110, or by using motors, or any other mechanical means connected to the projection surface 116 of the animatronic 106, as detailed below. In many embodiments, the actuator 110 is positioned beneath or behind the projection surface 116 to move it from behind and acts to deform or create ridges, recesses, or the like to the surface. Additionally, the projection system 108 may project content onto the projection surface 116 of the animatronic 106.

The projection system 108 may receive data from the controller 104. The data corresponds to content that is to be projected onto the animatronic 106. The projection system 108 may project the content onto the animatronic 106. The projection system 108 may include a projector (or more than one projector) having a lens system configured to control the image quality and/or magnification. The projection system 108 may optionally include one or more mirrors and/or one or more filters. In some cases, the projection system 108 may adjust what content is being projected onto the animatronic 106 or how the content is being projected onto the animatronic 106 to better align the projection of the content with the projection surface 116 of the animatronic 106. This may be achieved through the use of the sensors 112 that may collect data pertaining to the animatronic 106 and the lights 114 that may illuminate the animatronic 106. The collected data may be understood as data collected from tracking the animatronic 106 via the sensors 112 using any of the tracking procedures discussed herein. Note that the projection system 108 may be made up of one or more projectors and various different projectors (e.g., light, lasers, video, environmental projectors, etc.) that may be used in combination to achieve the projection of content onto the animatronic 106.

In some cases, the controller 104 may receive data from the animatronic 106 (e.g., topography, position, orientation, movement data) and from the projection system 108 (e.g., content-based data, data generated from the digital media itself, data on how the content is being projected (e.g., projection performance data), data from the sensors 112 and the lights 114). Additionally, the controller 104 may receive data collected by the sensors 112 corresponding to the animatronic 106 (e.g., data corresponding to tracking the animatronic 106). The controller 104 may use such data (e.g., feedback) to align the projection surface 116 of the animatronic 106 and the content being projected by the projection system 108. Additionally, the controller 104 may transmit such data received from the animatronic 106 and the projection system 108 to the server 102 for storage, for use in future animation or, in some cases, model training. The controller 104 may receive from the server 102, previous data obtained from the animatronic 106 and the projection system 108 to better align the projection surface 116 of the animatronic 106 and the content being projected by the projection system 108. The controller 104 may transmit mechanical movements to the animatronic 106 to be performed by the actuator 110 that may be used to adjust the topography of the projection surface 116 of the animatronic 106. The controller 104 may transmit content to the projection system 108 to be projected by the projection system 108 onto the projection surface 116 of the animatronic 106. Note that the mechanical movement parameters to adjust the topography of the projection surface 116 of the animatronic 106 may be inputted into the controller 104 by a user. Additionally, the content that is to be projected onto the animatronic 106 by the projection system 108 may be inputted into the controller 104 by a user or modified by the user to better align with the actuator 110 of the animatronic 106. The modification may take the form of modifying the timing of the content, modifying the lighting intensity and colors of the content, and/or modifying intended emotions/movements to be performed by the animatronic 106 via the actuator 110.

The server 102 may transmit stored data to the controller 104 and/or receive data from the controller 104 for storage corresponding to the animatronic 106 (e.g., topography, position, orientation, movement data) and to the projection system 108 (e.g., content based data, data on how the content is being projected from, for example, the sensors 112 and/or lights 114). In some examples, this data may be used for future animation and/or model training.

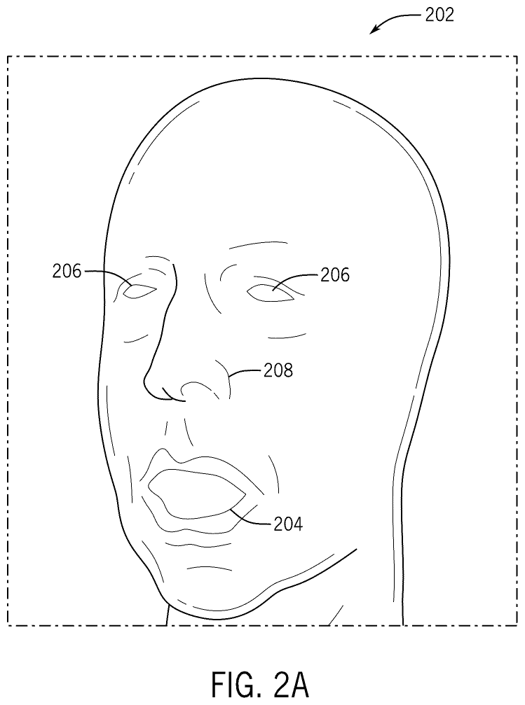

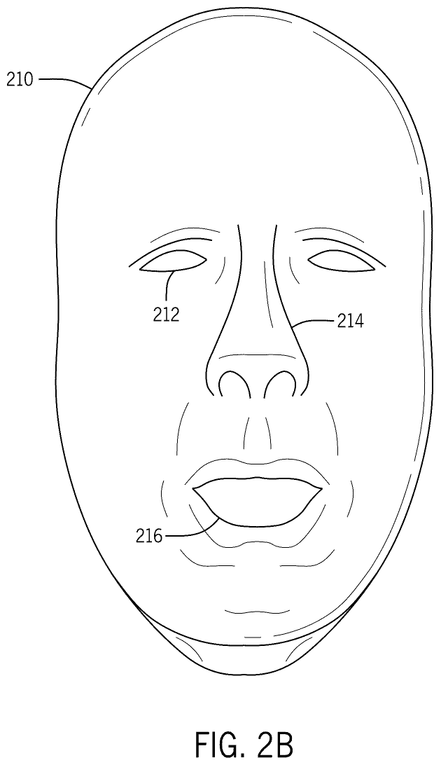

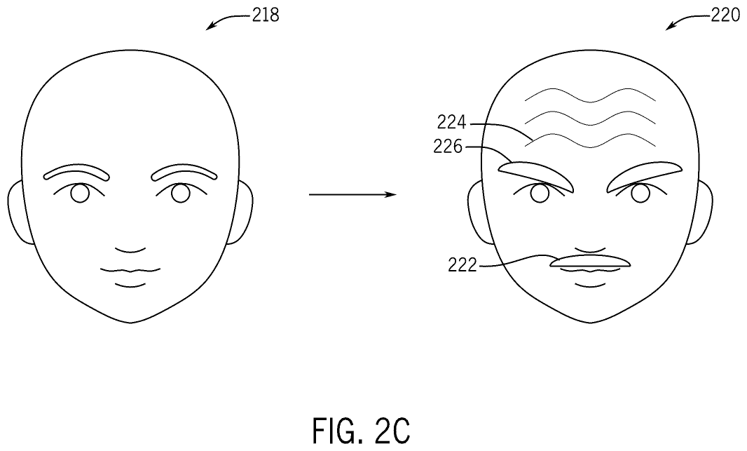

FIG. 2A illustrates an example animatronic figure (e.g., the animatronic 106 illustrated in FIG. 1) with a projection surface 202 (e.g., the projection surface 116, the skin 115, etc.) positioned over a robotic structure of the animatronic figure. In some embodiments, a projection surface 202 may be positioned over a robotic structure of, for example, the head of the animatronic figure (such as the projection surface 116 positioned over the animatronic 106 illustrated in FIG. 1). The projection surface 202 may include various shallow recesses or depressions resembling features such as a shallow recess for a mouth 204, shallow recesses for eyes 206, and a shallow recess for a nose 208. The shallow recesses of the mouth 204, the eyes 206, and the nose 208 are continuous with no apertures, tears, or openings as compared to deep recesses with apertures and openings used in current animatronic systems. The shallow recesses of the mouth 204, the eyes 206, and the nose 208 may allow for topographical mechanical changes on the projection surface 202. For example, the shallow recesses may form slack in the projection surface 202 that allows the projection surface 202 to be more readily formed into various shapes, e.g., pulled back to define a cavity for a mouth or pushed forward to define eyebrows or the like. The amount of excess or slack for the projection surface 202 depends on the desired features to be formed with the surface, as well as the flexibility of the projection surface 202 material. The projection surface 202 material may include one or a combination of silicon, neoprene, latex, cloth, and/or elastomers (e.g., self-healing or liquid crystal).

The topographical mechanical changes may be achieved by activating actuators (e.g., such as the actuator 110 illustrated in FIG. 1) that are attached to the projection surface 202. For example, an actuator may push, pull and/or stretch the projection surface 202, for example, to mimic facial movements (e.g., of a mouth, nose, eyebrows, eyes, cheeks, etc.). Note that one or more actuators may be connected to the projection surface 202, such as to manipulate the projection surface 202 as a whole, or specific regions thereof.

In some instances, the projection surface 202 does not initially include shallow recesses and is a continuous projection surface with no apertures, tears, or openings positioned over a robotic structure of, for example, the head of the animatronic figure. Accordingly, the actuators (or other mechanical means) may be used to manipulate (e.g., morph) the projection surface 202 to include/display the various shallow recesses resembling features such as the shallow recess for the mouth 204, shallow recesses for the eyes 206, and the shallow recess for the nose 208. Many conventional animatronics will have separate skin pieces that form a portion of the animatronic figure and will have openings, such as the mouth, ears, eyes, to allow other secondary elements to be inserted and used to form the animatronic effect. On the contrary, the present embodiments allow a single element, e.g., the projection surface 202, to be sufficiently manipulated to form these different elements and can change between convex and concave shapes to easily transform into different aesthetic features.

FIG. 2B illustrates an example of a projection surface 210 of an animatronic figure modified to align with content projected onto it. In various embodiments, topographical mechanical changes (made by mechanical means discussed herein) on the projection surface 210 allows the projection surface 210 to be formed into various shapes. For example, the projection surface 210 may be pulled back to form eyes 212, the projection surface 210 may be pushed out to form a nose 214, and the projection surface 210 may be pulled back to form a mouth 216, or a combination thereof. The topographical mechanical changes may be achieved by activating actuators (e.g., such as the actuator 110 illustrated in FIG. 1) that are attached to the projection surface 210. The actuator is attached to the projection surface 210 behind the projection surface 210 (e.g., in the animatronic) and manipulates the projection surface 210 by moving the projection surface 210. For example, an actuator may push, pull and stretch the shallow recess corresponding to the mouth 216, mimicking movement of a mouth. In another example, an actuator may push the middle of the shallow recess corresponding to the mouth 216 to mimic a tongue. Note that one or more actuators (or other mechanical means) may be connected (coupled) to each shallow recess, or each portion of the projection surface 210 to manipulate the shallow recesses themselves and/or to manipulate the projection surface 210 as a whole

FIG. 2C illustrates an example of a projection surface 218 of an animatronic figure and a projection surface 220 of an animatronic figure modified to align with content projected onto it. In some embodiments, an animatronic figure may include a projection surface 218, such as a blank or content free surface, with minimal texture (e.g., similar to a projection screen) where content is to be displayed/projected on. This may be the head of the animatronic figure or any other body part of the animatronic figure where content is to be displayed/projected onto. For example, the projection surface 218 may be a continuous surface wrapped around a structure forming a face of the animatronic figure and may include basic simplistic facial details, such as simplistic mouth, eyes, nose and eyebrow impressions. Note that the projection surface 218 is continuous and has no apertures, openings, or tears in it (including in areas of facial details such as the mouth, eyes, nose, ears and hair), as it is a continuous surface and extends over the mouth aperture to cover the aperture in the animatronic shell (in embodiments where there is such an aperture).

The projection surface 218 wraps fully or in part over a structure that includes actuator(s) (e.g., actuator 110) or any mechanical means to move the projection surface 218. For example, the actuator(s) may move, deform, morph, and/or stretch the projection surface 218 over the structure. Additionally, the actuator(s) may be configured to move, deform, morph, and/or stretch the projection surface 218 over the structure. Note that the number, configuration, and position of the actuator(s) and structure may depend on the desired animation and effect to be performed by the animatronic figure.

In some embodiments, actuators, motors, or any other mechanical means discussed herein may adjust and/or change the topography of the projection surface 218 to a manipulated projection surface 220, e.g., manipulated by moving or deforming the surface. For example, the projection surface 218 may be manipulated to align with the content to be projected onto the projection surface 220 and to enhance the movement effect, animating the projection surface 220.

Additionally, content may be projected onto the projection surface 220 (with an adjusted matching topography) as to animate the projection surface 220 of the animatronic figure. For example, the projection surface 220 of FIG. 2C is animated (topography changed and projected onto) to align with content that projects a mustache 222, wrinkles 224, and eyebrows 226, or other facial features, or a combination thereof, onto the projection surface 220. The mustache 222, wrinkles 224, and eyebrows 226, or other features, or a combination thereof, may move corresponding to the desired animation of the animatronic figure (e.g., move via the actuators). The projection surface 220 may be animated to showcase a multitude of human or non-human facial features, expressions, emotions, motions, and other animations of the sort that an animatronic figure is to perform or look like.

In some instances, a controller (e.g., the controller 104 illustrated in FIG. 1) may receive data corresponding to the change in topography of the projection surface 218 and/or projection surface 220 (or data corresponding to the projection surface 220 such as tracking data) and receive data corresponding to the content projected onto the projection surface 220 (e.g., the mustache 222, the wrinkles 224, and the eyebrows 226). The controller may analyze the received data to align the movement of the actuators manipulating the projection surface 220 with the content being projected onto the projection surface 220. The controller may continuously analyze the received data to continuously align the movement of the actuators manipulating the projection surface 220 with the content being projected onto the projection surface 220.

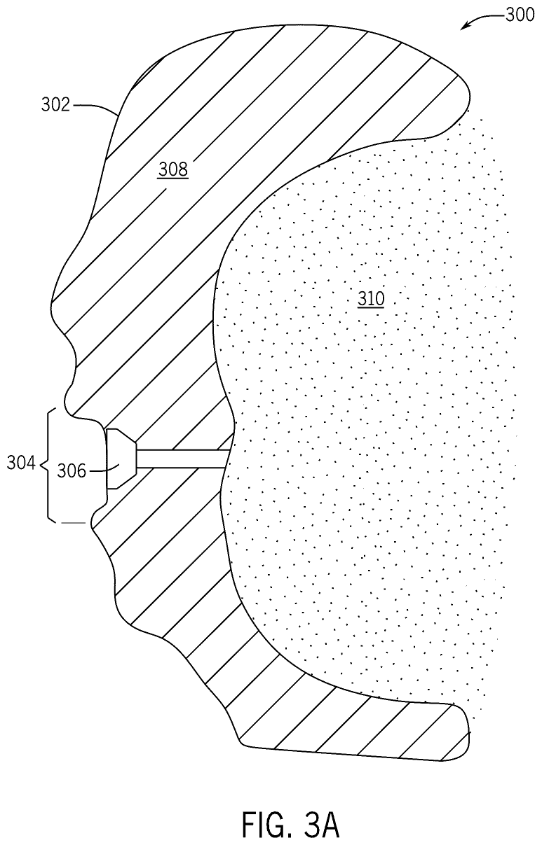

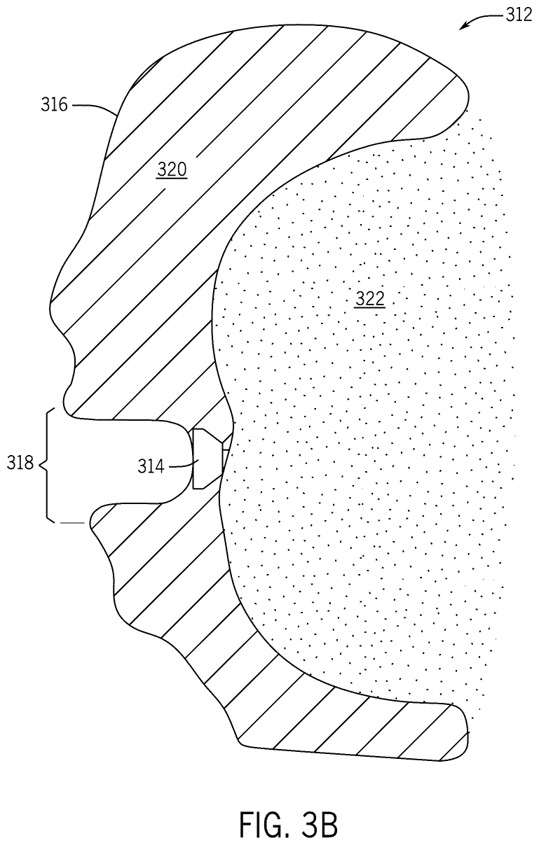

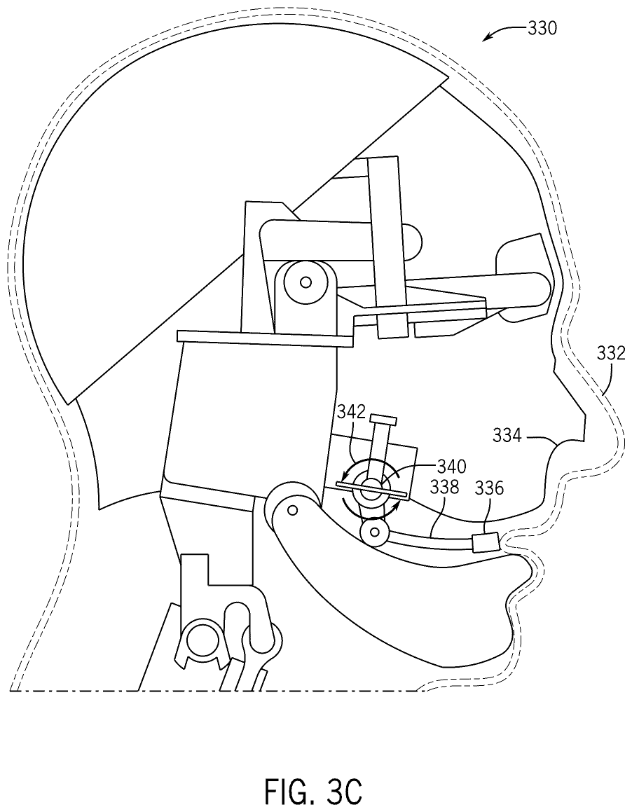

FIG. 3A illustrates a cross-section side view 300 of a projection surface 302 with an actuator 306 that is at rest. By way of example, the projection surface 302 is coupled to a shell 310 (illustrated with a dot pattern) of an animatronic, as discussed herein. Between the projection surface 302 and the shell 310 is space 308 (illustrated with crosshatching) into which the projection surface 302 may be deformed (e.g., pulled back into) using an actuator or other mechanical means discussed herein, thereby allowing an animatronic with the projection surface 302 to showcase an emotion or animation in combination with content projected onto the projection surface 302. The illustrated projection surface 302 includes an actuator 306 that is coupled to a mouth recess 304, as discussed herein. The actuator 306 is at rest (e.g., not activated), not pulling or morphing the skin corresponding to the mouth recess 304 of the projection surface 302. Note that the mouth recess 304 is not accentuated or overly morphed while the actuator 306 is at rest (e.g., not activated).

FIG. 3B illustrates a cross-section side view 312 of a morphed projection surface 316 with an activated actuator 314. By way of example, the morphed projection surface 316 is coupled to a shell 322 (illustrated with a dot pattern) of an animatronic, as discussed herein. Between the morphed projection surface 316 and the shell 322 is space 320 (illustrated with crosshatching) where the morphed projection surface 316 is deformed into using an actuator or other mechanical means discussed herein. For example, the skin corresponding to the mouth recess 318 of the morphed projection surface 316 is being pulled back into the space 320 between the morphed projection surface 316 and the shell 322 by an actuator 314 that is activated. As a result, the mouth recess 318 is accentuated and morphed to look like a mouth. Note that the mouth recess 318 may be continuously morphed by the actuator 314 to animate the mouth recess 318 to perform animations such as talking, eating, singing, etc.

While the mouth recess 318 of the morphed projection surface 316 is illustrated, it should be understood that mechanical means discussed herein may be used to morph any portion of the projection surface 316 by either pulling skin of the projection surface 316 into the space 320 between the projection surface 316 and the shell 322 or by pushing excess skin out of the space 320 between the projection surface 316 and the shell 322. This pulling and pushing of the projection surface 316 may allow for the showcasing of an intended emotion or animation on the animatronic with the projection surface 316.

FIG. 3C illustrates a cross-section side view 330 of a projection surface 332 with mechanical means for modifying the topography of the projection surface 332. The projection surface 332 is coupled to a shell 334 of the animatronic, such as defining a skin of the shell 334. The projection surface 332 may be coupled to the shell 334 in a manner as described below (e.g., mechanically secured or connected). Portions of the projection surface 332 (e.g., a mouth portion as illustrated) may be coupled to an actuator, where movement of the actuator varies the topography of the skin or projection surface 332.

In one example, the projection surface 332 is coupled to a mechanical connection 336. The mechanical connection 336 may be coupled to a link 338, and the link 338 may be coupled to a motor 340. As the motor 340 turns, the projection surface 332 may move via the link 338 and mechanical connection 336. For example, as the motor 340 turns in a first direction (e.g., clockwise or opposite direction 342 indicated in FIG. 3C), the mouth portion of the projection surface 332 is pulled inwardly (e.g., towards the motor 340, into the shell 334, etc.), such as to create a recess along the topography of the projection surface 332. In another example, as the motor 340 turns in a second direction (e.g., counterclockwise or in the direction 342 indicated in FIG. 3C), the mouth portion of the projection surface 332 is pushed outwardly (e.g., away from the motor 340, out of the shell 334, etc.), such as to reduce the recess along the topography of the projection surface 332. In this manner, actuation of the motor 340 may provide a varied shape for the mouth, allowing the mouth to move (e.g., to replicate talking, yawing, smiling, eating, or emotions).

In some instances, the mouth portion of the projection surface 332 may be understood as a mouth bag that, when moved and/or modified by the movement of the motor 340, may deform the topography of the projection surface 332 to showcase a mouth and any motion and movement that may be performed by the mouth. In these examples, the mechanical action (e.g., forces) exerted by the mechanical coupling acts to change the topographical shape of the projection surface 332, such as to create a deeper recess or cavity to form an open mouth; to change a portion to create a tongue, teeth, or gumline, and/or to create differently shaped and sized openings in the mouth; to create a protrusion or bump in the projection surface 332 (e.g., to mimic sticking out the tongue, etc.). Because the projection surface 332 spans across an opening in the shell 334, the projection surface 332 can be pulled inwards to create the deeper recess, or can be pushed away from the shell 334 to create a shallower or flat mouth portion. In many examples, the projection surface 332 defines an uninterrupted surface over the shell aperture or apertures (e.g., mouth openings or the like) that allows a freer form and bidirectional change of the topography of the projection surface 332. That is, the projection surface 332 can be deformed to be recessed and/or protruded from the same mechanical motion and shell support.

While in the illustrated example a motor 340 is used to modify the mouth portion of the projection surface 332, it should be understood that any mechanical mechanisms, such as motors, links, and the like, including others as discussed herein may be connected to and used to morph or modify any portion of the projection surface 332 by either pulling skin of the projection surface 332 or by pushing excess skin of the projection surface 332. Further, while in the illustrated example a link 338 is used to connect the mechanical connection 336 to the motor 340, any means of connecting the mechanical connection 336 to the motor 340 may be implemented (as discussed herein).

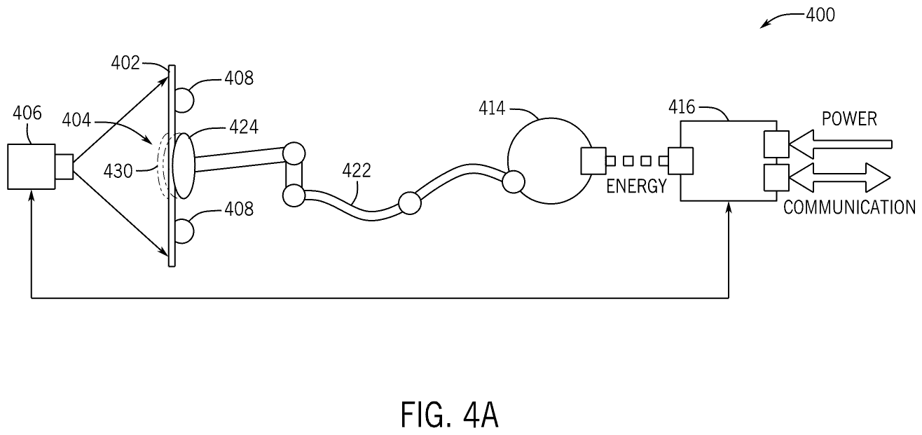

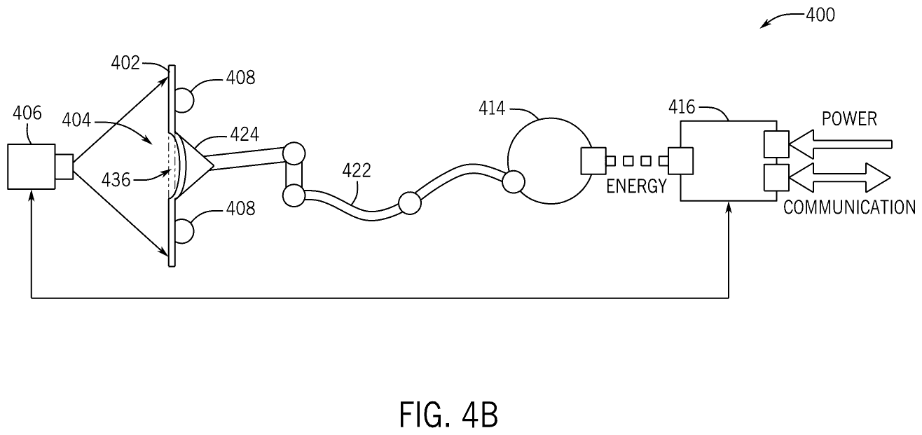

FIG. 4A illustrates a simplified schematic of an actuator system 400 for mechanically moving a projection surface (e.g., the skin 115 or projection surface 116, 202, 210, 218, 220, 302, 316, or 332; hereinafter “skin” 402 without intent to limit) of an animatronic figure, with the actuator system 400 providing a positive displacement of the skin 402 at a location 404. The location 404 may be the mouth 204, the eyes 206, the nose 208, a wrinkle 216, an eyebrow 218, or another facial location or feature. The location 404 may be a recess, depression, indentation, cavity, protrusion, or another area of the skin 402. The location 404 may be an area where deformation or movement of the skin 402 is desired, such as to provide realistic animation, either alone or in combination with content projection onto the skin 402 by a projector 406 (e.g., the projection system 108).

The skin 402 may be secured to the animatronic figure. For example, one or more skin constraints 408 may secure the skin 402 to the animatronic figure. The skin constraints 408 may be defined by a shell (e.g., the shell 310 or 322, or portions thereof) or structure of the animatronic figure. In another example, the skin constraints 408 may be mechanical fasteners securing the skin 402 to the animatronic figure. In another example, the skin constraints 408 may be defined by the skin 402 itself, such as a flap, tab, or post of skin material extending for coupling to the shell. In another example, the skin constraints 408 may be defined by complementary engagement structures, such as a component of the skin 402 and a component of the shell working in tandem to create a secure connection (e.g., a matching fit between the components, a male/female connection, mating surfaces, etc.). The skin constraints 408 may hold the skin 402 in place over the robotic structure of the animatronic figure.

The actuator system 400 may include an actuator 414. The actuator 414 may include motors, solenoids, pumps, pneumatic actuators, hydraulic actuators, shape memory alloys, or other mechanical means. The actuator 414 may be driven by electrical energy and/or controlled via a control signal, such as provided by a controller 416 (e.g., the controller 104). The controller 416 may receive power and communication. In some examples, the controller 416 is communicatively coupled to the projector 406, such as to coordinate content projection with mechanical movement of the skin 402, as described above.

The actuator system 400 may include a mechanical transmission 422 coupling the actuator 414 to the skin 402 (e.g. at the location 404). The mechanical transmission 422 may include one or more elements, such as one or multiple links, connections, gears, or the like. The mechanical transmission 422 may be rigid or semi-rigid, include pneumatic or hydraulic tubing, include tensile elements, or a combination thereof. The type and number of elements may be determined to fit the actuator system 400 to or within the animatronic figure. In one example, the mechanical transmission 422 includes a coupler 424 engaging the skin 402. The coupler 424 may be secured to or form a part of a rigid link of the mechanical transmission 422. In another example, the coupler 424 may be part of the shell or structure to which the skin 402 is attached. For example, the coupler 424 may be formed as part of a flexible tab or beam of the shell, where the tab or beam flexes with actuation of the mechanical transmission 422 to move the skin 402.

When activated, the actuator system 400 may move the coupler 424 to shape the skin 402. For example, the actuator 414 may push the coupler 424 outward, thereby pushing the skin 402 outward to define a visible protrusion or feature 430 at the location 404 (e.g., providing a positive displacement of the skin 402 at the location 404). When the actuator system 400 is deactivated, the coupler 424 may return inward, such as under the resilient bias of the skin 402 or a reversing of the actuator 414 or mechanical transmission 422, thereby flattening the protrusion 430 at the location 404.

FIG. 4B illustrates the actuator system 400, with the actuator system 400 providing a negative displacement of the skin 402 at the location 404. In some examples, the coupler 424 may be fixed to the skin 402, such as attached to the inner surface of the skin 402. In such examples, activation of the actuator system 400 may pull the skin 402 inward to define or emphasize a recess 436 at the location 404 (e.g., providing a negative displacement of the skin 402 at the location 404). When the actuator system 400 is deactivated, the coupler 424 may return outward, such as under the resilient bias of the skin 402 or a reversing of the actuator 414 or mechanical transmission 422, thereby reducing the recess 436 at the location 404. In other examples, the actuator system 400 may either push or pull the skin 402 at the location 404 based on the control signal provided to the actuator 414. For example, a first control signal (e.g., a first voltage) provided to the actuator 414 may push the skin 402 outward at the location 404, with a second control signal (e.g., a second, opposite voltage) provided to the actuator 414 pulling the skin 402 inward at the location 404.

When combined with content projected onto the skin 402 via the projector 406, the deformation of the skin 402 at the location 404 may create a realistic and immersive experience not possible to generate solely with mechanical motion or content projection alone. For example, facial expressions and features may appear more realistic. Additionally, or alternatively, unique animations, not possible using traditional techniques, may be provided.

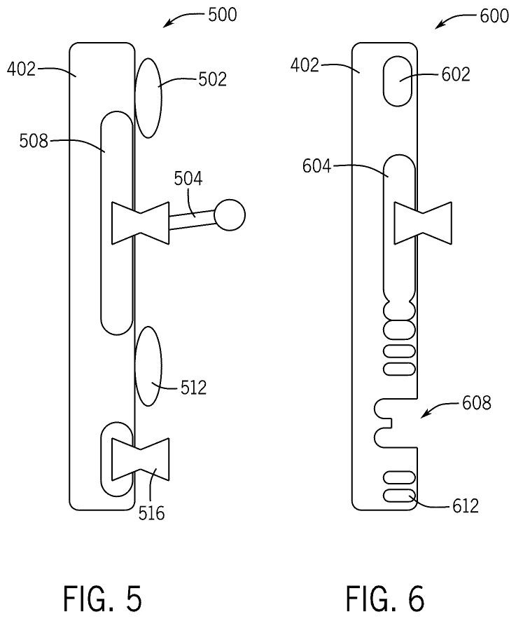

FIG. 5 illustrates a first set of shaping features 500 configured to define a shape of a projection surface (e.g., the skin 402) of an animatronic figure. The first set of shaping features 500 may include an active attachment. The active attachment may be a moving portion of the shell or actuator system 400. For example, the skin 402 may be coupled to an active shell connection 502. The active shell connection 502 may be a movable portion of the shell, such as a flexible tab, beam, or other component of the shell, where the active shell connection 502 flexes, bends, slides, or translates to move or manipulate the skin 402 with actuation of the actuator system 400. In this manner, the active shell connection 502 may be an indirect connection to the actuator system 400. In such examples, the actuator system 400 may move the shell to manipulate the skin 402.

In another example, the active attachment may be an actuator attachment 504. The skin 402 may include the actuator attachment 504. For example, the actuator attachment 504 may be embedded within or formed with the skin 402. The actuator attachment 504 may be coupled to the mechanical transmission 422. In this manner, the mechanical transmission 422 may be coupled directly to the skin 402. In some examples, the skin 402 includes a substrate 508. The substrate 508 may be an inner layer or element of the skin 402 (e.g., an inner substrate). The substrate 508 may define the actuator attachment 504, or the actuator attachment 504 may be coupled to the substrate 508. When actuated, the mechanical transmission 422 may move the substrate 508 directly to move or manipulate the skin 402. Moving the substrate 508 may provide regional motion of the skin 402.

In another example, the first set of shaping features 500 may include a static attachment. The static attachment may fix or hold the skin 402 in place. For example, the static attachment may include a static shell connection 512. The static shell connection 512 may be a fixed portion of the shell that does not move with actuation of the actuator system 400. The static shell connection 512 may be an abutting engagement of the skin 402 with the shell. For example, the static shell connection 512 may abut the inner surface of the skin 402 to limit inward movement of the skin 402 at the static shell connection 512. The abutting engagement of the static shell connection 512 with the inner surface of the skin 402 may allow outward movement of the skin 402 away from the static shell connection 512. In this manner, the static shell connection 512 may define a stop to limit inward movement of the skin 402 only. In some examples, the abutting engagement may allow lateral movement of the skin 402 relative to the static shell connection 512, such as to allow the skin 402 to stretch or slide relative to the static shell connection 512. The static attachment may be a mechanical attachment fixing the skin 402 to the shell.

In another example, the static attachment may include a fixed attachment 516 between the shell and the skin 402. The fixed attachment 516 may fix the skin 402 to the shell. For example, the fixed attachment 516 may limit movement of the skin 402 relative to the shell. In one example, the fixed attachment 516 may limit movement of the skin 402 along or about multiple axes (e.g., along or about two axes, along or about all three axes).

The skin 402 may be coupled to the actuator system 400 or shell using any number or combination of the first set of shaping features 500. For example, the skin 402 may be coupled to the shell using any number or combination of active shell connections 502, static shell connections 512, or fixed attachments 516. Additionally, or alternatively, the skin 402 may be coupled to the actuator system 400 using any number or combination of actuator attachments 504. The number, type, and location of the first set of shaping features 500 (e.g., active attachments, static attachments) may define the deformation of the skin 402 (e.g., a desired movement to mimic facial expressions) when the actuator system 400 is actuated.

FIG. 6 illustrates a second set of shaping features 600 configured to define a shape of a projection surface (e.g., the skin 402) of an animatronic figure. The second set of shaping features 600 may include one or more features, characteristics, or elements of the skin 402 itself. For example, the second set of shaping features 600 may include a first substrate 602. The first substrate 602 may be an inner layer or element of the skin 402 (e.g., an inner substrate). The first substrate 602 may be more flexible or softer than the skin 402. For example, the first substrate 602 may be more flexible or more elastic compared to the skin 402. In another example, the first substrate 602 may be softer in durometer compared to the skin 402. In one example, the first substrate 602 may be softer to define a localized soft region of the skin 402 (e.g., to promote or induce folding, wrinkling, scrunching, or a different deformation of the skin 402 when the actuator system 400 is actuated). In this manner, the first substrate 602 may have an elasticity or durometer different than the skin 402 itself.

In another example, the second set of shaping features 600 may include a second substrate 604. The second substrate 604 may be an inner layer or element of the skin 402 (e.g., an inner substrate). The second substrate 604 may have an elasticity or durometer different than the skin 402. For example, the second substrate 604 may be stiffer or harder than the skin 402. In one example, the second substrate 604 may be less flexible or less elastic compared to the skin 402. In another example, the second substrate 604 may be harder in durometer compared to the skin 402. In one example, the second substrate 604 may be stiffer to define a localized stiff region of the skin 402 (e.g., to limit or define a different folding, wrinkling, scrunching, or other deformation of the skin 402 when the actuator system 400 is actuated). The second substrate 604 may be stiffer than the first substrate 602.

The first substrate 602 and/or second substrate 604 may be distributed within the skin 402 to define a desired stiffness of the skin 402. For example, the first substrate 602 and/or second substrate 604 may be distributed to define a directional stiffness of the skin 402, such that the skin 402 is stiffer in one direction relative to a second direction to define localized folding, wrinkling, scrunching, or a different deformation of the skin 402 when the actuator system 400 is actuated. In another example, the substrate and/or second substrate 604 may be distributed to define a stiffness gradient along the skin 402, such that the skin 402 reduces or increases in stiffness along a dimension of the skin 402 (e.g., towards or away from a facial feature, in depth, etc.).

In another example, the second set of shaping features 600 may include a relief 608 in a surface of the skin 402. The relief 608 may be a cut, a groove, a recess, or a hole in the surface, or a combination thereof. The relief 608 may be formed through a removal of material that breaks through the surface of the skin 402. The surface may be an inner surface or an outer surface of the skin 402. The relief 608 may be localized to promote or induce folding, wrinkling, scrunching, or a different deformation of the skin 402 at or adjacent the relief 608 when the actuator system 400 is actuated. Multiple reliefs 608 may be distributed along the surface of the skin 402 to vary or define the deformation.

In another example, the second set of shaping features 600 may include a void 612 within the skin 402. The void 612 may be a hollow volume inside the skin 402, such as an open space completely encapsulated by the skin 402. The void 612 may be shaped to define localized folding, wrinkling, scrunching, or a different deformation of the skin 402 when the actuator system 400 is actuated. For example, the void 612 may be elongated (e.g., between the outer and inner surfaces of the skin 402) and/or positioned nearer the outer surface or the inner surface of the skin 402 (e.g., nearer the inner surface). In another example, multiple voids 612 may be distributed within the skin 402 to vary or define the deformation.

The skin 402 may include any number or combination of the second set of shaping features 600. For example, the skin 402 may include any number or combination of first substrates 602, second substrates 604, reliefs 608, or voids 612. The number, type, and location of the second set of shaping features 600 may define the deformation of the skin 402 (e.g., a desired movement to mimic facial expressions) when the actuator system 400 is actuated.

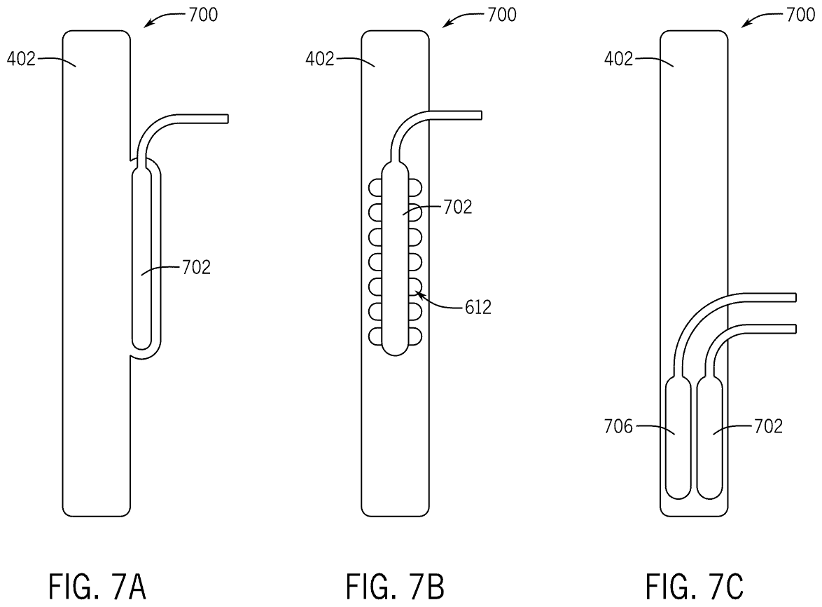

FIGS. 7A-7C illustrate a third set of shaping features 700 configured to define a shape of a projection surface (e.g., the skin 402) of an animatronic figure. The third set of shaping features 700 may include one or more devices to induce localized bending, buckling, or a different deformation of the skin 402 because of relative actuation. Referring to FIG. 7A, the third set of shaping features 700 may include a first device 702 attached to or incorporated with the skin 402. The first device 702 may be connected to a surface of the skin 402 (e.g., attached to the inner surface or a different surface of the skin 402). Alternatively, the first device 702 may embedded, at least partially, in the skin 402. In one example, the first device 702 includes a bladder. The bladder may be selectively filled with air or fluid to cause deformation of the skin 402. For example, filling the bladder with air or fluid may enlarge the bladder (e.g., lengthen the bladder, widen the bladder, etc.), cause the bladder to assume a shape, or a combination thereof. Conversely, draining the bladder of air or fluid may reduce the bladder (e.g., shorten the bladder, shrink the bladder, etc.), cause the bladder to assume a different shape, or a combination thereof. Enlarging or reducing the bladder may induce a deformation of the skin 402, such as causing the skin 402 to bend, fold, or buckle. The first device 702 may be positioned to define the location of deformation.

In another example, the first device 702 includes a shape memory alloy (SMA) (e.g., a smart metal or alloy, a memory metal or alloy, etc.). The SMA may change shape in response to temperature changes or electrical current. For example, an electrical current may be passed through the SMA to heat the SMA. Heating the SMA may cause the SMA to assume a first shape. Conversely, cooling the SMA may cause the SMA to assume a different shape. For example, the electrical current may be turned off, allowing the SMA to cool down. The SMA may have a one-way memory or a two-way memory. The first shape may induce a first deformation of the skin 402, such as causing the skin 402 to bend, fold, buckle, or straighten in a first manner. The second shape may induce a second deformation of the skin 402, such as causing the skin 402 to bend, fold, buckle, or straighten in a second manner.

Referring to FIG. 7B, the first device 702 may be incorporated within the skin 402 itself. For example, the first device 702 may be inserted or formed with the skin 402. Positioning the first device 702 within the skin 402 may define a deformation different than one produced when the first device 702 is attached to the skin's surface. In one example, the first device 702 may be combined with the second set of shaping features 600 to define a desired deformation. For example, the first device 702 may be positioned near or adjacent one or more voids 612 or other shaping features to vary the local tension or buckling of the skin 402, among other deformations.

Referring to FIG. 7C, the third set of shaping features 700 may include a second device 706. The second device 706 may be similar to or different than the first device 702. For example, each of the first device 702 and the second device 706 may include a bladder or an SMA. In another example, the first device 702 may include a bladder, and the second device 706 may include an SMA. The first device 702 and second device 706 may be layered within the skin 402. For example, the first device 702 and second device 706 may be positioned side-by-side within the skin 402. Activation of the first device 702 and the second device 706 may be synchronous or different. For example, the first device 702 and second device 706 may be activated at the same time or at different times (e.g., staggered). In another example, only one of the first device 702 or the second device 706 may be activated. In another example, the first device 702 and second device 706 may be activated at varying levels or degrees. For example, the first device 702 may be filled, drained, or activated to a first level, and the second device 706 may be filled, drained, or activated to a different, second level. Selective activation of the first device 702 and/or the second device 706 may induce a deformation of the skin 402, such as causing the skin 402 to bend, fold, buckle, or straighten in various manners.

The skin 402 may include any number or combination of the third set of shaping features 700. For example, the skin 402 may include any number or combination of first devices 702 or second devices 706. The number, type, and location of the third set of shaping features 700 may define the deformation of the skin 402 (e.g., a desired movement to mimic facial expressions) when the actuator system 400 is actuated.

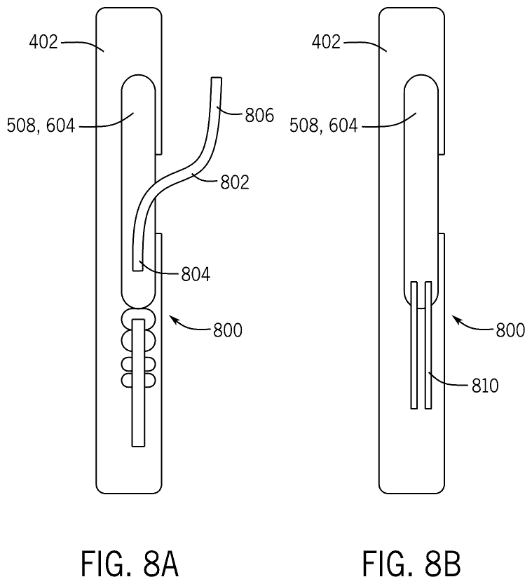

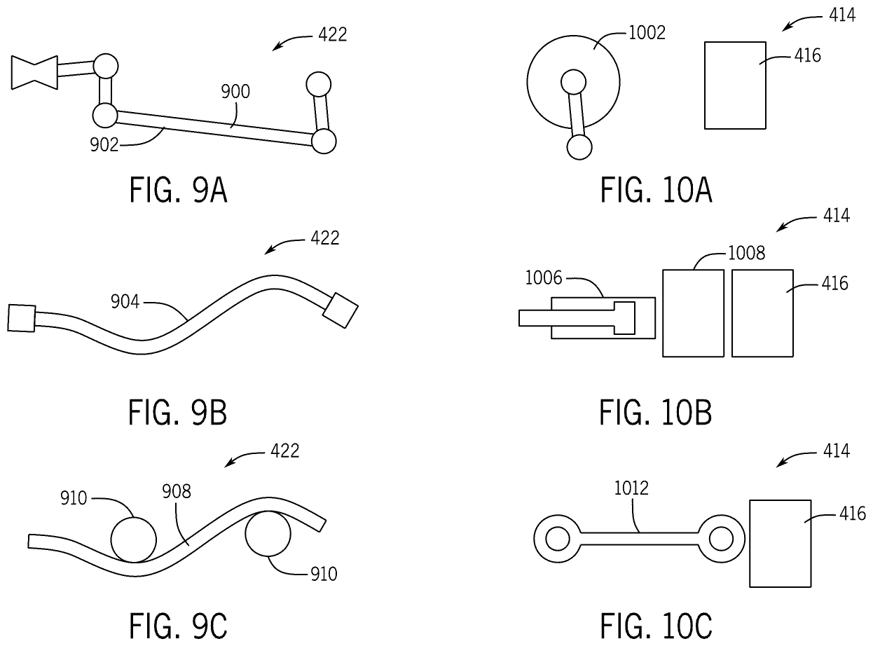

FIGS. 8A-8B illustrate a fourth set of shaping features 800 configured to define a shape of a projection surface (e.g., the skin 402) of an animatronic figure. The fourth set of shaping features 800 may include one or more embedded features to induce localized bending, buckling, or a different deformation of the skin 402 because of relative actuation. Referring to FIG. 8A, the fourth set of shaping features 800 may include a first embedded element 802. The first embedded element 802 may be a rigid or flexible element. The first embedded element 802 may be a fabric or tendon (e.g., a non-stretch fabric) embedded, at least partially, within the skin 402. For example, the first embedded element 802 may include a first end 804 and a second end 806. The first end 804 may be embedded within the skin 402, with the second end 806 being a free end positioned outside the skin 402. The first end 804 may be connected to a substrate (e.g., substrate 508, second substrate 604, etc.). The first end 804 may be manipulated to deform the skin 402. For example, the second end 806 may be pulled to move the first end 804 within the skin 402. In some examples, the second end 806 may be connected to a mechanical transmission (e.g., the mechanical transmission 422 illustrated in FIGS. 4A, 4B, 9A, 9B, or 9C) to manipulate (e.g., push, pull, twist) the first embedded element 802.

Referring to FIG. 8B, the fourth set of shaping features 800 may include a second embedded element 810. The second embedded element 810 may be a fiber or multiple fibers embedded entirely within the skin 402. The second embedded element 810 may be connected to a substrate (e.g., substrate 508, second substrate 604, etc.). The second embedded element 810 may provide localized directional strength or reinforcement to the skin 402. For example, the second embedded element 810 may prevent localized stretching where positioned.

The skin 402 may include any number or combination of the fourth set of shaping features 800. For example, the skin 402 may include any number or combination of first embedded elements 802 or second embedded elements 810. The number, type, and location of the fourth set of shaping features 800 may define the deformation of the skin 402 (e.g., a desired movement to mimic facial expressions) when the actuator system 400 is actuated.

FIGS. 9A-9C illustrate example transmission elements for transferring a motive force to a shaping feature. Referring to FIG. 9A, the mechanical transmission 422 may include a linkage 900. The linkage 900 may be a rigid linkage having one or multiple links 902. The linkage 900 may transfer linear or rotational movement of the actuator 414, to the skin 402, or shaping features. For example, the linkage 900 may be a reverse-motion linkage, a push-pull linkage, a parallel-motion linkage, a bell-crank linkage, a four-bar linkage, a straight-line generator, a slider-crank mechanism, a scotch-yoke mechanism, or a different linkage.

Referring to FIG. 9B, the mechanical transmission 422 may include a tubing 904. The tubing 904 may be pneumatic tubing or hydraulic tubing to transfer pneumatic or hydraulic forces to the skin 402 or shaping features. For example, the tubing 904 may be used to fill or drain the third set of shaping features 700 (e.g., bladders) illustrated in FIGS. 7A-7C.

Referring to FIG. 9C, the mechanical transmission 422 may include a tensile element 908. The tensile element 908 may include a rope, cable, or fiber to transfer a pulling force on the skin 402 or shaping features. For example, the actuator 414 may pull the tensile element 908 to provide a negative displacement of the skin 402 at the attachment of the tensile element 908 to the skin 402. The tensile element 908 may be routed around one or more pulleys or slides 910. The pulleys or slides 910 may be fixed or movable by the actuator 414. For example, the pulleys or slides 910 may move to generate the pulling force on the skin 402.

FIGS. 10A-10C illustrate example actuators for providing a motive force for the actuator system 400. Referring to FIG. 10A, the actuator 414 may include an electric motor 1002. The electric motor 1002 may include or be communicatively coupled to the controller 416. The electric motor 1002 may generate rotational motion or force. The mechanical transmission 422 (e.g., the linkage 900) may be coupled to the electric motor 1002, such that rotation of the electric motor 1002 operates the mechanical transmission 422.

Referring to FIG. 10B, the actuator 414 may include a linear actuator 1006. The linear actuator 1006 may be a pneumatic actuator or a hydraulic actuator. The linear actuator 1006 may include or be communicatively coupled to the controller 416. In some examples, the linear actuator 1006 includes one or more valves 1008. The valves 1008 may be operated by the controller 416 to control fluid flow to or from the linear actuator 1006 (e.g., to control a position or movement of the linear actuator 1006). The mechanical transmission 422 (e.g., the tubing 904) may be coupled to the linear actuator 1006.

Referring to FIG. 10C, the actuator 414 may include an SMA 1012. The controller 416 may vary electrical current applied to the SMA 1012. For example, the controller 416 may increase or decrease applied electrical current to heat or cool the SMA 1012, with the temperature of the SMA 1012 defining a shape of the SMA 1012. The SMA 1012 may be coupled to the skin 402 or a shaping feature, such that changing the shape of the SMA 1012 pushes, pulls, or otherwise biases the skin 402 to deform. The SMA 1012 may be coupled directly to the skin 402 or shaping features, or indirectly via a mechanical transmission 422 (e.g., the linkage 900 or tensile element 908).

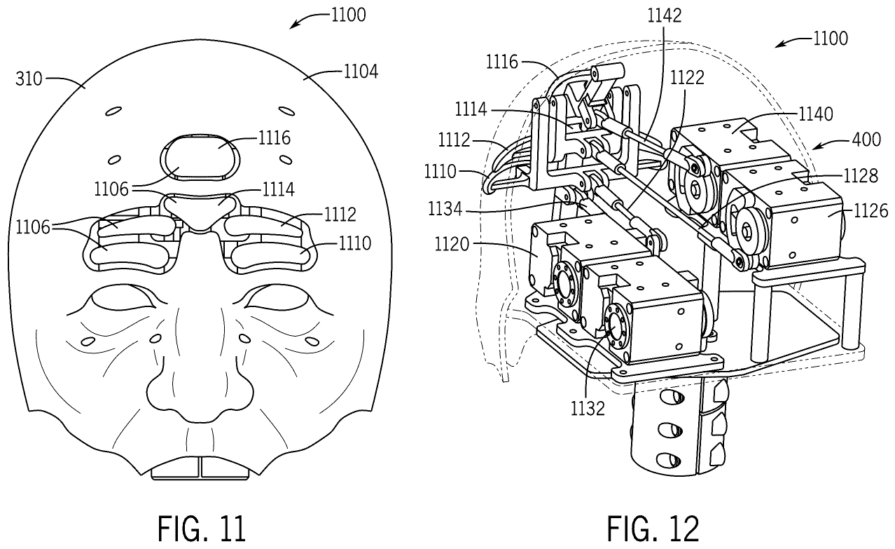

FIGS. 11-12 illustrate an example implementation of a system disclosed herein (e.g., the system 100, the actuator system 400), for example, a robotic system 1100. The robotic system 1100 includes the shell 310 and the actuator system 400. The shell 310 may define an underlying structure for at least a portion of the robotic system 1100 (e.g., the head of the animatronic 106). The shell 310 may include fixed portions 1104 and movable portions 1106. The fixed portions 1104 may define a structure or shape for one or more first facial features (e.g., the nose, eyes, cheeks, skull, etc., or a combination thereof). The movable portions 1106 may define a structure or shape for one or more second facial features (e.g., eyebrows, forehead, mouth, etc., or a combination thereof). The movable portions 1106 may move relative to the fixed portions 1104 (e.g., via the actuator system 400), such as to create deformation in the skin 402. The skin 402 may span over both the fixed portions 1104 and the movable portions 1106 (e.g., continuously). The skin 402 may move with the movable portions 1106 relative to the fixed portions 1104, such as to create deformation of the skin 402. In one example, the movable portions 1106 may be portions of the shell 310 that bend or flex. In another example, the movable portions 1106 may be portions separate from the fixed portions 1104.

The skin 402 (not shown, see FIGS. 3A-3B) may be coupled to the shell 310 and define a projection surface, such as in a manner as described above. In such examples, movement of the movable portions 1106 may move the skin 402 to mimic facial expressions, such as the motion and positioning of muscles beneath the skin 402 of the face. For example, the movable portions 1106 may move up and down, left and right, or in and out to mimic eyebrow movement, forehead movement, squinting, etc.

The actuator system 400 may operate the movable portions 1106. For example, one or more actuators 414 may drive the mechanical transmission 422 to move the movable portions 1106. As shown, the movable portions 1106 may include a first movable portion 1110 representing one or both eyebrows, a second movable portion 1112 representing a first muscle in the forehead, a third movable portion 1114 representing a second muscle in the forehead, and a fourth movable portion 1116 representing a third muscle in the forehead, or a combination thereof. The movable portions may be coupled to respective actuators 414. For example, the first movable portion 1110 may be coupled to a first actuator 1120 via a first mechanical transmission 1122. The second movable portion 1112 may be coupled to a second actuator 1126 via a second mechanical transmission 1128. The third movable portion 1114 may be coupled to a third actuator 1132 via a third mechanical transmission 1134. The fourth movable portion 1116 may be coupled to a fourth actuator 1140 via a fourth mechanical transmission 1142. In FIG. 12, each of the first, second, third, and fourth mechanical transmission 1122, 1128, 1134, 1142 is illustrated as a rigid link, although other configurations are contemplated.

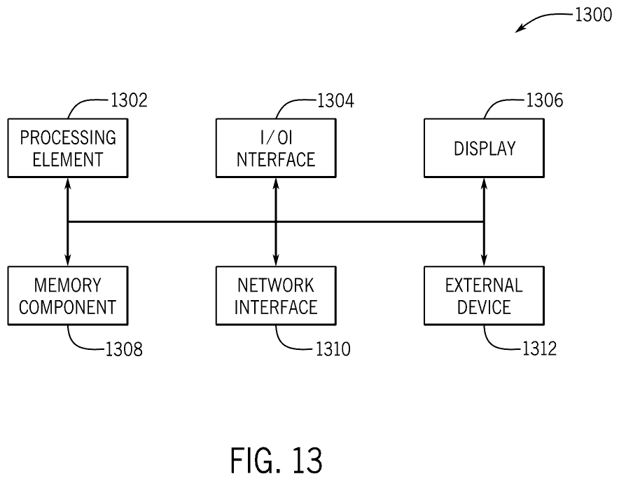

FIG. 13 is a simplified block diagram of components of a computing system 1300 of the system 100, such as the server 102, the controller 104, the controller 416, etc. For example, the processing element 1302 and the memory component 1308 may be located at one or in several computing systems 1300. This disclosure contemplates any suitable number of such computing systems 1300. For example, the server 102 may be a desktop computing system, a mainframe, a blade, a mesh of computing systems, a laptop or notebook computing system, a tablet computing system, an embedded computing system, a system-on-chip, a single-board computing system, or a combination of two or more of these. Where appropriate, a computing system 1300 may include one or more computing systems 1300; be unitary or distributed; span multiple locations; span multiple machines; span multiple data centers; or reside in a cloud, which may include one or more cloud components in one or more networks. A computing system 1300 may include one or more processing elements 1302, an input/output I/O interface 1304, one or more external devices 1312, one or more memory components 1308, and a network interface 1310. Each of the various components may be in communication with one another through one or more buses or communication networks, such as wired or wireless networks, e.g., the controller 104. The components in FIG. 13 are exemplary only. In various examples, the computing system 1300 may include additional components and/or functionality not shown in FIG. 13.

The processing element 1302 may be any type of electronic device capable of processing, receiving, and/or transmitting instructions. For example, the processing element 1302 may be a central processing unit, microprocessor, processor, or microcontroller. Additionally, it should be noted that some components of the computing system 1300 may be controlled by a first processing element 1302 and other components may be controlled by a second processing element 1302, where the first and second processing elements may or may not be in communication with each other.

The I/O interface 1304 allows a user to enter data in to computing system 1300, as well as provides an input/output for the computing system 1300 to communicate with other devices or services. The I/O interface 1304 can include one or more input buttons, touch pads, touch screens, and so on.

The external device 1312 are one or more devices that can be used to provide various inputs to the computing systems 1300, e.g., mouse, microphone, keyboard, trackpad, sensing element (e.g., a thermistor, humidity sensor, light detector, etc. The external devices 1312 may be local or remote and may vary as desired. In some examples, the external devices 1312 may also include one or more additional sensors.

The memory components 1308 are used by the computing system 1300 to store instructions for the processing element 1302, as well as store data. The memory components 1308 may be, for example, magneto-optical storage, read-only memory, random access memory, erasable programmable memory, flash memory, or a combination of one or more types of memory components.

The network interface 1310 provides communication to and from the computing system 1300 to other devices. The network interface 1310 includes one or more communication protocols, such as, but not limited to Wi-Fi, Ethernet, Bluetooth, etc. The network interface 1310 may also include one or more hardwired components, such as a Universal Serial Bus (USB) cable, or the like. The configuration of the network interface 1310 depends on the types of communication desired and may be modified to communicate via Wi-Fi, Bluetooth, etc.

The display 1306 provides a visual output for the computing system 1300 and may be varied as needed based on the device. The display 1306 may be configured to provide visual feedback and may include a liquid crystal display screen, light emitting diode screen, plasma screen, or the like. In some examples, the display 1306 may be configured to act as an input element through touch feedback or the like.

The computing system 1300 may be include a physical device or separate physical devices including components to read and execute instructions from a machine-readable or computer-readable medium (e.g., a non-transitory machine-readable storage medium).

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. While the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. An animatronic comprising:
a shell;
a skin coupled to the shell; and
an actuator configured to selectively create a deformation of the skin, wherein the deformation is configured to complement content projected onto the skin.

2. The animatronic of claim 1, wherein the actuator comprises a mechanical transmission configured to provide a positive or negative displacement of the skin at a location.

3. The animatronic of claim 1, wherein the shell comprises a fixed portion and a movable portion, wherein the actuator is configured to move the movable portion relative to the fixed portion to create the deformation.

4. The animatronic of claim 3, wherein the skin spans over the fixed portion and the movable portion, and wherein the skin is configured to move with the movable portion relative to the fixed portion.

5. The animatronic of claim 1, wherein the skin comprises an inner substrate coupled to the actuator.

6. The animatronic of claim 5, further comprising a mechanical attachment coupling the skin to the shell.

7. The animatronic of claim 1, wherein the actuator abuts an inner surface of the skin, such that the deformation is only caused by a positive displacement of the actuator.

8. The animatronic of claim 1, wherein the skin comprises an inner substrate, a relief, or a void to define a localized deformation of the skin.

9. The animatronic of claim 8, wherein the substrate, the relief, or the void defines a directional stiffness of the skin to define the shape.

10. The animatronic of claim 8, wherein the skin comprises multiple substrates, multiple reliefs, or multiple voids to define the localized deformation of the skin.

11. An animatronic comprising:
a shell;
a skin covering the shell; and
an actuator system configured to move the skin to change a topography of the skin to mimic a facial expression.

12. The animatronic of claim 11, wherein the actuator system comprises a movable portion of the shell and an actuator configured to move the movable portion.

13. The animatronic of claim 11, wherein the actuator system comprises a motor and a linkage, and wherein the skin comprises an attachment coupling the linkage to the skin.

14. The animatronic of claim 13, wherein the skin comprises an inner substrate defining the attachment.

15. The animatronic of claim 11, wherein the actuator system comprises a bladder associated with the skin, the bladder configured to change shape based on a fluid pressure within the bladder.

16. The animatronic of claim 15, wherein the bladder is attached to an inner surface of the skin.

17. A robotic system comprising:
a shell;
a skin coupled to the shell and defining a continuous projection surface;
a projector configured to project content onto the continuous projection surface; and
an actuator system mechanically coupled to the skin and configured to selectively create a deformation of the skin that complements the content projected onto the skin.

18. The robotic system of claim 17, wherein the actuator system comprises a motor and a linkage coupling the motor to the skin.

19. The robotic system of claim 17, wherein the actuator system comprises an actuator and a bladder, wherein the actuator comprises a pneumatic or hydraulic actuator, and wherein the bladder is configured to change shape based on a fluid pressure within the bladder.

20. The robotic system of claim 17, wherein the actuator system comprises a shape memory alloy or a tensile element.
